(19) United States
(12) Patent Application Publication
(10) Pub. No.: US 2017/0159255 A1
(43) Pub. Date: Jun. 8, 2017

(54) REMEDIATION PAD STRUCTURE

(71) Applicant: OPFLEX TECHNOLOGIES, LLC, Indianapolis, IN (US)

(72) Inventor: Scott C. Smith, Osterville, MA (US)

(21) Appl. No.: 15/306,988

(22) PCT Filed: Apr. 22, 2015
(86) PCT No.: PCT/US2015/027109

§ 371 Date: Oct. 26, 2016

Related U.S. Application Data
(60) Provisional application No. 61/983,271, filed on Apr. 23, 2014.
(60) Provisional application No. 62/022,728, filed on Jul. 10, 2014.

(51) Int. Cl. E02B 15/10; C02F 1/28; B32B 27/36; B32B 5/02; B32B 27/12; B32B 27/08; C02F 1/40; B32B 5/18

(52) U.S. Cl. CPC E02B 15/101; C02F 1/40; C02F 1/285; B32B 5/18; B32B 5/028; B32B 27/12; B32B 27/08; B32B 27/36; C02F 2101/32

(57) ABSTRACT

A remediation pad that includes a layer of an open cell foam material defining opposing major surfaces and a reinforcing layer that is disposed adjacent one of the major surfaces. Some embodiments include a second layer of open cell foam material disposed adjacent the reinforcing layer opposite the first layer. The reinforcing layer may take the form of a mesh or film layer and can be substantially coextensive with the major surfaces it abuts. A plurality of fastening structures can be disposed on opposite ends of the pad whereby a plurality of the pads can be connected end-to-end to form an endless loop. The fastening structures may take the form of a hook and loop fasteners. A method of employing such pads when they form an endless loop is also disclosed.

### CROSS REFERENCE TO RELATED APPLICATIONS

This application claims priority of U.S. provisional patent application Ser. No. 61/983,271 filed on Apr. 23, 2014 entitled ADSORBENT AND ABSORBENT BELT BOOM and of U.S. provisional patent application Ser. No. 62/022,728 filed on Jul. 10, 2014 entitled ADSORBENT AND ABSORBENT BELT BOOM/BLANKET/PAD the disclosures of both of which are hereby incorporated herein by reference.

### BACKGROUND

The present disclosure relates to methods and apparatus for recovering contaminants from a body of water or dry surface.

Liquid hydrocarbons, such as oil, are one of the most frequent contaminants that are the subject of clean-up efforts. Oftentimes, releases of such hydrocarbons take place on or near of a body of water resulting in the necessity of recovering the hydrocarbons from the body of water.

Various methods have been developed for removing hydrocarbons from a body of water. For example, skimmers, which vacuum the top layer of liquid on a water body, can be effective when the hydrocarbons are still highly concentrated at the upper surface of the water body. Adsorbent/absorbent materials may also be used to recover hydrocarbons from a body of water. Such materials may take the form of a buoyant booms or pads which collect hydrocarbons in the water body. Open cell foam structures such as that disclosed by U.S. Pub. No. 2013/0240451 A1 entitled APPARATUS AND METHODS FOR REMOVING CONTAMINANTS FROM A LIQUID by Curtis, Jr. et al., the disclosure of which is hereby incorporated herein by reference, can also be used to collect hydrocarbons in a water body.

While many of the existing technologies are useful for remediating environmental contamination, further developments in this area remain desirable.

### SUMMARY

The present invention provides a strong and durable remediation pad that can be used repeatedly to recover contaminants from either a body of water or from a ground surface.

The invention comprises, in one form thereof, a remediation pad that includes a first layer of an open cell foam material defining first and second opposing major surfaces and a reinforcing layer that is disposed adjacent the first major surface and wherein the reinforcing layer is secured to the pad.

In some embodiments, the remediation pad further includes a second layer of open cell foam material defining third and fourth opposing major surfaces wherein the third major surface is disposed adjacent the reinforcing layer opposite the first layer and wherein the second layer is secured to the pad. The reinforcing layer may advantageously be substantially coextensive with the first and third major surfaces which it abuts. The first, second, third and fourth major surfaces may also be substantially planar surfaces.

In other embodiments, the remediation pad defines first and second opposing ends and includes a plurality of fastening structures wherein at least one of the fastening structures is disposed on each of the first and second ends whereby the pad is adapted to be connected end-to-end with additional pads having the same configuration. In such embodiments, the fastening structures can be formed by hook and loop fasteners. Those embodiments which include fastener structures may advantageously have fastening structures that are secured to the reinforcing layer.

In some embodiments, the reinforcing layer is a mesh material. In other embodiments, however, the reinforcing layer may be formed out of a film material.

The open cell foam material may advantageously include foam that is formed out of ethyl methacrylate (EMA). In some such embodiments, the open foam material is approximately 100% EMA.

In some embodiments, there is a plurality of pads wherein each of the pads defines first and second opposing ends and includes at least one fastening structure on each of the first and second opposing ends, the fastening structures being detachably securable together whereby the plurality of pads are securable together in an end-to-end configuration to thereby form an endless loop.

The invention also comprises, in another form thereof, a method of recovering contaminants from a body of water using a remediation pad as disclosed herein. The method includes securing a plurality of the pads together in an endless loop; deploying at least a portion of the endless loop in the body of water; circulating the plurality of pads along the endless loop such that each one of the plurality of pads is repeatedly introduced into the body of water and removed from the body of water; and expressing liquid from each of the plurality of pads when it is removed from the body of water and before it is returned to the body of water to thereby recover contaminants from the body of water.

In some embodiments, this method may include using remediation pads wherein each of the plurality of pads has first and second opposing ends, the first and second opposing ends of each pad being detachably secured to an adjacent one of the plurality of pads to form the endless loop and wherein the plurality of pads are detachably secured together. Such a method may advantageously allow an individual damaged one of the pads to be removed and replaced with an undamaged pad.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a schematic view of an endless loop of material being used to recover contaminants.

FIG. 2 is a schematic view of the endless loop.

FIG. 3 is a schematic view of nip rollers being used to recover contaminants.

FIG. 4 is a top view of an individual pad.

FIG. 5 is a schematic side view showing two pads connected together.

FIG. 6 is a schematic exploded perspective view of a pad.

FIG. 7 is a schematic exploded side view of a pad.

FIG. 8 is a schematic side view showing two pads connected together.

FIG. 9 is a schematic side view of two pads that can be connected together.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

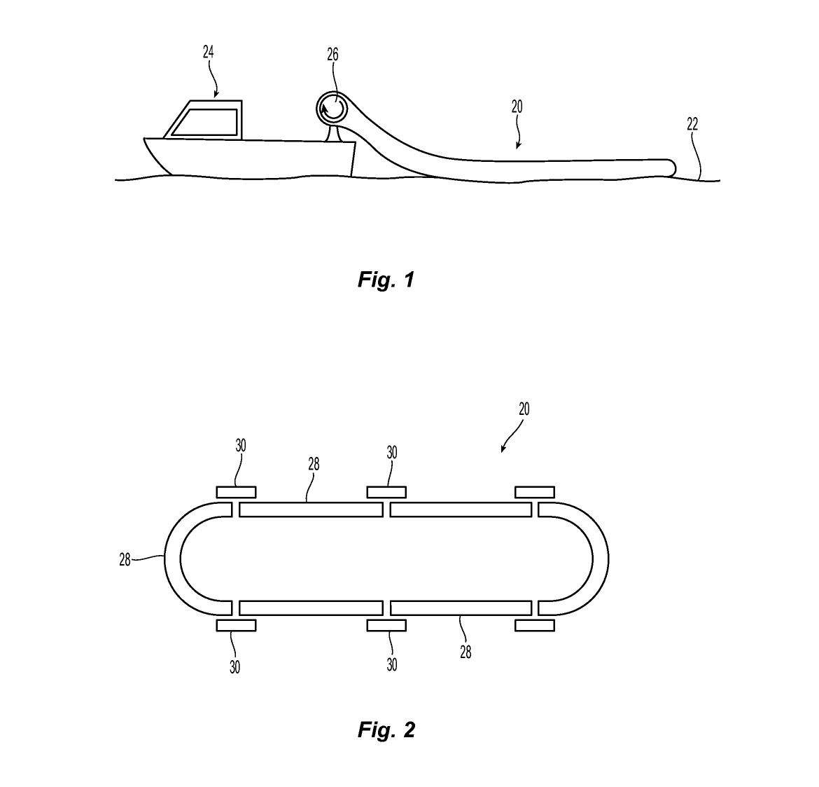

FIG. 1 illustrates an endless loop 20 of remediation pads 28 floating on the surface of a body of water 22 and which are being towed by a boat 24. A mechanical device 26 is schematically depicted in FIG. 1 and circulates the endless loop of pads 28 such that each pad 28 is repeatedly introduced into and then removed from the body of water 22. Device 26 advantageously also includes a pair of nip rollers 32 for expressing contaminated liquid 34 from pads 28. Endless loop 20 is schematically depicted in FIG. 2 and includes a plurality of remediation pads 28 that secured together end-to-end with connectors or fastening structures 30 to form an endless loop 20 which may also be referred to as a belt boom.

Fastening structures 30 can be temporary or detachable, i.e., they can be used to attach and detach adjacent pads 28 without destruction of the pads or fastening structures 30, or can be permanent, i.e., destruction of at least a portion of the fastening structures 30 or pads 28 would be necessary to detach the secured pads 20. Examples of how pads 28 can be attached include butt welding, adhesive butt joints, overlap joints, sewing, mechanically fastening and using an intermediate attachment layer to which the sections are secured.

Advantageously, pads 28 are detachably secured together using temporary fastening structures 30 such as hook and loop fasteners. The fastening structures 30 can be secured to pads 28 mechanically, e.g., stitching; chemically, e.g., adhesives; ultrasonic welding or other suitable means known to those having ordinary skill in the art. Fastening structures 30 may not only be disposed at opposite ends of pads 28 to permit end-to-end securement but may also be disposed on lateral sides of pads 28 whereby pads 28 can be secured together to increase the width of the assembled pads 28.

Pads 28 include a layer of polymer foam that can adsorb oil and other hydrocarbons. One example of such a polymer foam is a foam formed using ethylene alkyl acrylate, for example, ethyl methacrylate (EMA). The polymer may include a copolymer. The polymer foam is advantageously an open-celled foam so that it will also absorb liquids, e.g., liquid hydrocarbons, into the open cell foam structure. Exemplary, but non-limiting, materials that can be used to form suitable open-celled foam are disclosed in U.S. Pub. No. 2011/0287929 A1 entitled FOAM COMPOSITIONS FOR SELECTIVE RECOVERY OF OIL SPILLS AND OTHER APPLICATIONS by Smith et al. and U.S. Pub. No. 2013/0240451 A1 entitled APPARATUS AND METHODS FOR REMOVING CONTAMINANTS FROM A LIQUID by Curtis, Jr. et al. and the disclosures of both are incorporated herein by reference.

The use of an open cell foam advantageously allows for the absorption of liquid hydrocarbons and other contaminated liquids into the open-celled structure of the foam. It is also advantageous when the foam material, e.g., EMA, is capable of adsorbing contaminants such as such as oil, petroleum distillates and other non-polar substances and hydrocarbons from a water body or ground surface. Such foam material can also be used to collect other organometal compounds and metals that become attached to or chelated with various hydrocarbons as well as a wide variety of other contaminants.

The open cell foam material used in pads 28 is advantageously at least about 70% EMA (by weight) and, even more advantageously, is about 100% EMA. The material may be a copolymer of a methacrylate. To enhance oil adsorption and absorption, the open cells of the foam material have a diameter of from about 1 mm to about 3 mm.

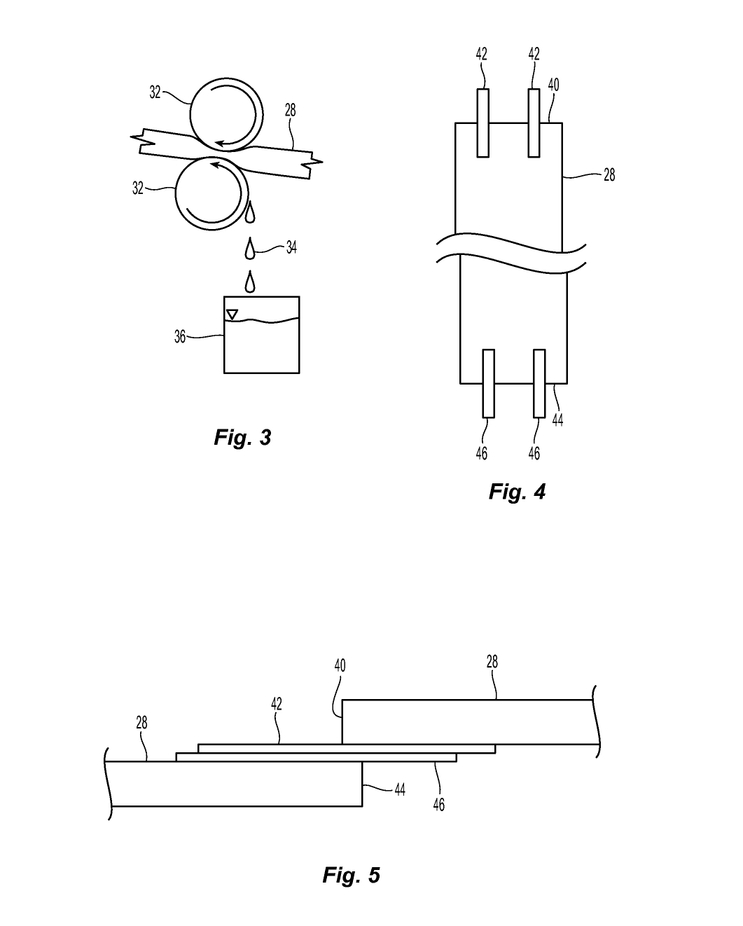

When used to collect contaminants in a body of water, pads 28 will float on the surface of the water or can have weighted objects attached thereto to submerge the pads below the surface of the water. When used to skim liquid hydrocarbons from the surface of water body or below the surface, pads 28 will eventually become saturated with contaminated liquid. The contaminated liquid can be readily removed from pads 28 by passing pads 28 between a pair of nip rollers 32 to express contaminated fluid 34 as schematically depicted in FIG. 3. A container 36 is used to capture contaminated fluid 34. The fluid 34 is then either properly disposed of or subjected to recovery processes to recover and reuse at least some of the contaminants present in fluid 34. After expressing a majority of the liquid from pad 28, pad 28 can be immediately reused to collect additional contaminated liquids.

It is noted that the term pad as used herein does not imply a specific size, shape or configuration and the disclosed pads 28 may have varied lengths, widths and thicknesses and may be used either individually or in assemblages of multiple pads to function as belt booms or endless loops, blankets, floating booms, mitts and various other applications for recovering contaminants. Exemplary dimensions include thickness of about 0.5 inch (1.27 cm) to about 8 inches (20.32 cm); width can be from about 4 inches (10.16 cm) to about 60 inches (152.4 cm); and the length can be selected for the intended application with 12 feet (3.66 m) being one example. As mentioned above, individual pads 28 can be used in isolation or joined together to form a larger assemblage.

Pads 28 advantageously, but not necessarily, includes a means for interconnecting them to another pad 28. One non-limiting example is the use of hook and loop mechanical fasteners such as those sold under the trademark Velcro™. As can be seen in FIG. 4, pad 28 may include mechanical fasteners 42, 46 at opposing ends 40, 44 of pad 28. In this example, first fasteners 42 at first end 40 are formed by strips of material having a panel of hook material disposed thereon while second fasteners 46 located at second end 44 are formed by strips of material having a panel of loop material disposed thereon. FIG. 5 schematically depicts two pads 28 which have been secured together in an end-to-end arrangement using fastening structures 42, 46. The number and size of the fasteners can be adjusted to provide the necessary grip strength. The size of pads 28, anticipated stresses imposed by the action of the water body and anticipated weight of adsorbed/absorbed materials all contribute to the maximum anticipated grip strength required for the fasteners. Hook and loop type fasteners will generally have sufficient strength and flexibility to provide for the secure attachment of adjacent pads 28, however, other fasteners may also be employed.

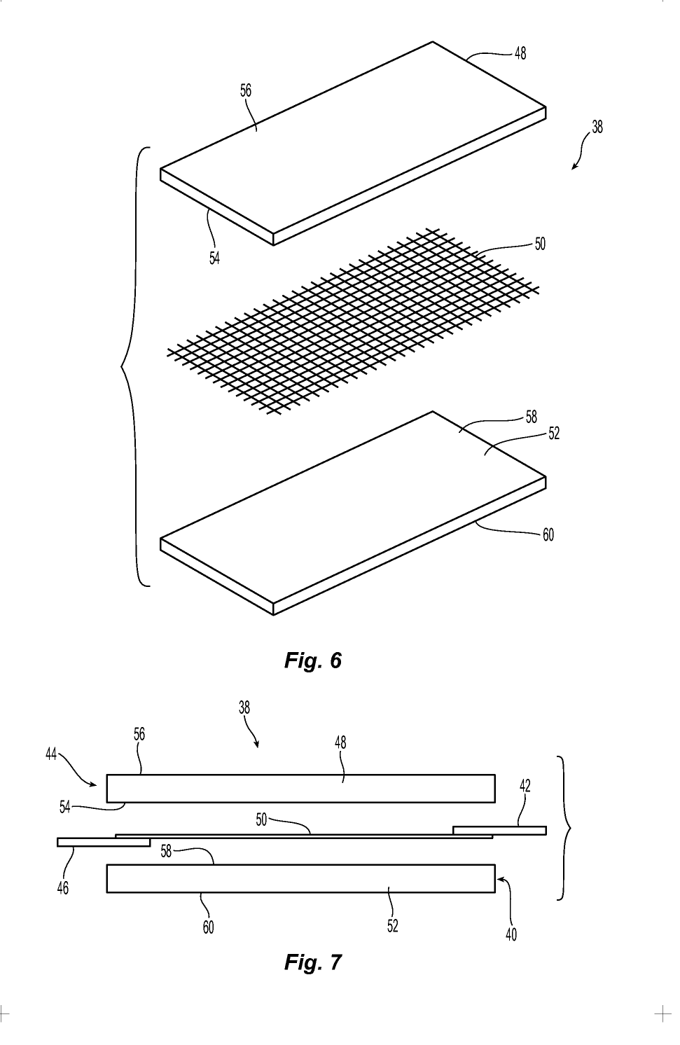

Pad 28 advantageously includes a reinforcement layer 50 to increase the strength of pad 28. In the example illustrated in the exploded view of FIG. 6, a reinforcement layer 50 is disposed between a first layer of open cell foam material 48 having a generally rectangular shape and a second layer of open cell foam material 52. In the illustrated example, layers 48, 50 and 52 all have a generally rectangular shape, however, alternative shapes can also be employed. It is also noted that while the illustrated foam layers 48, 52 have a consistent thickness with each layer having the same thickness, other arrangements could also be employed. For example, the exterior, exposed surface of the foam layers 48, 52 could have irregularities to increase the exposed surface area available for collecting contaminated substances. Also, in some applications it might be desirable for one of the layers to have a greater thickness than the other layer. For example, if the two foam layers were formed using different polymer compositions, it might be desirable for one of the layers to have a different thickness than the other layer.

In the embodiment of FIG. 6, pad 38 has a first layer of foam 48 which defines first and second opposing major planar surfaces 54, 56 with reinforcing layer 50 substantially coextensive with and disposed adjacent the first major planar surface 54. Similarly, second layer of foam 52 defines third and fourth opposing major planar surfaces 58, 60 with the third major planar surface being substantially coextensive with and disposed adjacent the reinforcing layer 50 opposite the first layer of foam 48. The two foam layers 48, 52 and the reinforcing layer 50 are secured together to form the pad structure using adhesives, stitching, heat welding, thermoforming or other suitable means known to those having ordinary skill in the art.

While it will often be desirable for the reinforcing layer to be coextensive with a major surface of the foam layer, alternative embodiments may employ reinforcing layers which have a more limited coverage and are not coextensive with the surface against which the reinforcing layer abuts.

In the illustrated embodiment, pad 38 is formed using two open-cell foam layers 48, 52 each having a thickness of approximately 0.25 inches (0.64 cm) and formed out of 100% EMA. Because mesh layer 50 has a minimal thickness that is embedded within the adjacent foam layers, the resulting pad 38 has an overall thickness of approximately 0.5 inches (1.27 cm).

The use of a reinforcing layer provides the pad with greater material strength. This allows the pad to be repeatedly subjected to mechanical forces when removing contaminants from the pad, e.g., by passing through a pair of nip rollers, and thereby prolongs the useful life of the pad. Because reinforcement layer 50 is coextensive with major surfaces 54, 58 of the foam layers 48, 52, i.e., layer 50 extends over a substantial majority of the surface area defined by major surfaces 54, 58, reinforcement layer 50 enhances the strength of foam layers 48, 52 over a broad area which enhances the ability of pad 38 to be repeatedly subjected to a contaminant removal process such as being passed between a pair of nip rollers 32. In this regard, it is noted that the illustrated coextensive mesh layer in FIG. 6 does not cover the entire surface area of the major surfaces 54, 58 it abuts because of its open structure, but it does extend for a length and width that is substantially equivalent to the length and width of the abutted major surfaces 54, 58.

The increased strength provided by the reinforcing layer also facilitates the use of the pad in applications where the pad is subjected to tensile stresses. For example, towing a series of end-to-end connected pads behind a boat will subject the pads to tensile stresses and circulating a series of pads connected end-to-end in an endless loop will also subject the pads to tensile stresses. The use of a reinforcement layer 50 allows the pads to withstand greater tensile forces without failure.

It is further noted that it will generally be advantageous for fastening structures such as fasteners 42, 46 to be secured to reinforcement layer 50 instead of a foam layer 48, 52. This arrangement provides for an efficient transfer of tensile forces between pads which have been secured together. The exploded view provided by FIG. 7 illustrates fastener structures 42, 46 being directly secured to reinforcement layer 50. In other embodiments, fastener structures can be secured to the reinforcement layer with directly engaging the reinforcement layer. For example, if a foam layer were disposed between the fastening structure and reinforcing layer, the fastening structure and reinforcing layer could still be secured together with stitching that extended through the foam layer. Similarly, if the intermediate foam layer were completely saturated with an adhesive at the location of the fastening structure, the adhesive could secure the fastening structure to the reinforcing layer.

The reinforcement layer 50 can be a mesh or film that has the tensile strength necessary for the application for which the pads will be used. Various different materials are suitable for use as the reinforcement layer. For example, polypropylene netting/mesh is widely available in various configurations and a configuration having the desired strength characteristics can be selected. Nylon scrim can also be used as a mesh reinforcement layer. Various film materials could be used instead of a mesh layer. For example, a film made from high-density polyethylene such as that sold under the trademark Tyvek® could be used as a reinforcement layer.

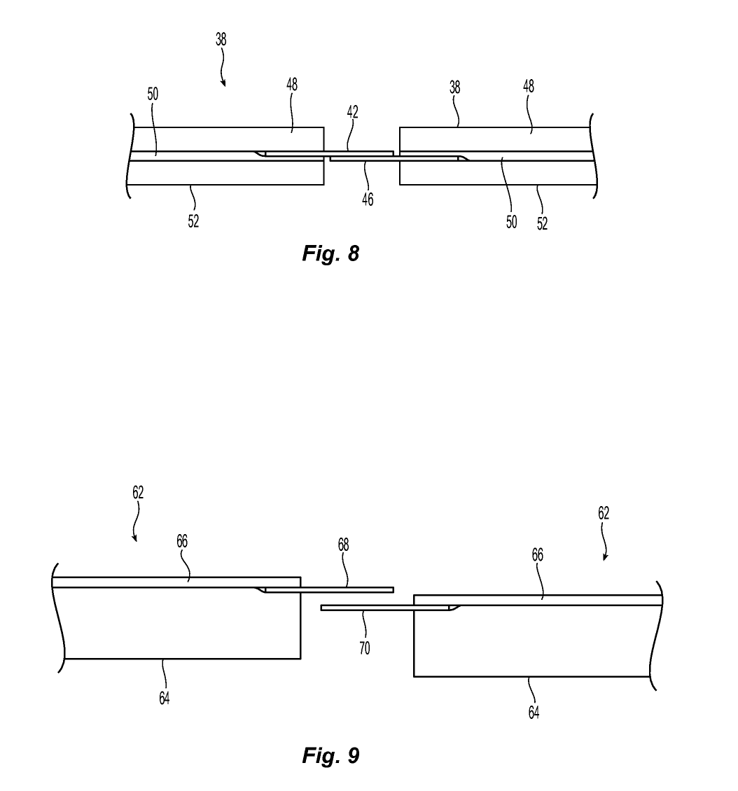

Various configurations of foam layers and reinforcement layers can be used to form a remediation pad. For example, FIGS. 6-8 show a pad 38 having two foam layers 48, 52 disposed on opposite sides of reinforcing layer 50. An alternative pad 62 is illustrated in FIG. 9 which has a single foam layer 64 and a reinforcing layer 66. In still other embodiments, more than two layers of foam could be used. In such embodiments, it may be advantageous to employ a reinforcing layer between each pair of adjacent foam layers. In embodiments which are intended for use in harsh conditions, it may be desirable to employ a reinforcing layer on each major surface of each foam layer. In this regard, it is noted that a mesh reinforcing layer disposed on an exterior surface of a foam layer allows for a significant percentage of the surface area of the foam layer to be exposed to the surrounding environment whereby it may still collect contaminants. It is further noted that the use of a mesh layer between two layers of foam allows for the internal migration of liquids through the open cell foam structure and can be beneficial in the functioning of the pad in both the initial collecting of the contaminated liquid and the expression of the collected liquid from the pad. Through holes extending through the pad, including the reinforcing layer, may also be employed to increase the exposed surface area and enhance liquid collection and expression.

As mentioned above, FIG. 9 discloses a pad 62 which includes a single open-cell foam layer 64 and a reinforcing layer 66. Fastening structures 68, 70, e.g., hook and loop fasteners, are located on opposite ends of each pad 62. Layer 66 may take the form of either a mesh or film layer. In one application, layer 66 may be a film layer with a plurality of pads 62 being joined end-to-end to form an endless loop. In such a configuration, film layer 66 of each pad 62 can be positioned so that it faces the interior of the endless loop with the foam layer 64 facing outward. This allows foam layer 64 to be exposed to the water surface when deployed behind a boat 24 as depicted in FIG. 1 while the relatively smooth film layer 66 facilitates the travel of pads 62 along the endless loop.

The remediation pads disclosed herein have a wide variety of uses and can be used as an individual pad or joined together for use. An individual pad can be deployed on a water surface or ground surface (including both natural earth and floor surfaces) and left in place to absorb contaminants. It can then be removed, the contaminants wrung out and the pad reused. An incomplete listing of where such pads might be used includes bays, marinas, storm drains, bilges, oil spills on land or on a body of water. For example, a pad 28 can be placed on the bank of a river in which oil has spilled to capture released oil. Pads can be placed under motor vehicles when changing oil to capture spills.

The pads disclosed herein can also be secured together for use. For example, a group of pads secured together could be towed behind a boat to capture contaminants or could be strung together to act as a boom whereby the pads encircle the contaminants to both limit the spread of the contaminants and recover the contaminant.

One particularly advantageous use of the pads disclosed herein is the securement of a plurality of such pads together in an endless loop. As schematically depicted in FIG. 1, the endless loop 20 can be deployed in body of water 22 such that at least a portion of the endless loop is in the body of water. The pads are circulated along the endless loop 20 such that each one of the plurality of pads is repeatedly introduced into the body of water and removed from the body of water. A rotating drive mechanism 26 can be used to circulate the pads along the endless loop.

As the pads are circulated along the endless loop, individual pads will be removed from the water and will contain contaminated liquid. This liquid can be expressed from the pads using any suitable method before the pads are returned to the water to recover additional contaminants. One non-limiting process for removing adsorbed/absorbed contaminants is shown in FIG. 3 where a pair of nip rollers 32 is used to express contaminated fluid 34.

By maneuvering the boat and circulating the endless loop 20, contaminants in water body 22 can be effectively recovered. The pads may be moved into contact with the contaminant through either or both of the movement of boat 24 and circulation of the pads along endless loop 20. In other words, watercraft 24 can be used to pull endless loop 20 to bring it into contact with contaminants and/or endless loop 20 can be rotated such that different sections of endless loop 20 are being brought into contact with water body 22 and the contaminants therein.

For example, if the contaminant load is relatively heavy, the endless loop 20 may be continuously circulated, constantly removing contaminant laden pads from the water to express liquid therefrom while the boat remains substantially stationary. Alternatively, the boat may maneuver across the water surface while the endless loop 20 is continuously circulated.

If the contaminant load is relatively lighter, boat 24 can be used to tow endless loop 20 through the water and the endless loop is only circulated when the section of loop 20 in contact with the water body has become saturated with oil or other contaminants. The endless loop of pads 20 is then circulated sufficiently to remove the saturated pads from the water and subject them to an operation that removes the adsorbed/absorbed contaminants while a cleaned portion of endless loop 20 is returned to the water body where it can be towed behind boat 20. The cleaned portion of endless loop 20 then collects contaminants and the cycle of periodic circulation of the endless loop for removal of contaminants from the loop is repeated.

Endless loop 20 can be formed to any suitable length using any number of pads. The pads are advantageously detachably secured together (for example, by the use of hook and loop fasteners) such that the pads can be configured and reconfigured as necessary. Forming an endless loop out of a plurality of pads wherein each pad is detachably secured to an adjacent one of the plurality of pads not only allows the length of the endless loop to be easily adjusted but also facilitates the convenient replacement of a damaged pad. For example, it would be a simple matter for an individual damaged one of the pads to be removed and replaced with an undamaged pad when the plurality of pads are secured together using detachable fasteners such as hook and loop fasteners. Various other uses and modifications to the pads disclosed herein are also possible and within the scope of the invention.

While this invention has been described as having an exemplary design, the present invention may be further modified within the spirit and scope of this disclosure. This application is therefore intended to cover any variations, uses, or adaptations of the invention using its general principles.

1. A remediation pad comprising:
a first layer of an open cell foam material defining first and second opposing major surfaces; and
a reinforcing layer disposed adjacent the first major surface and wherein the reinforcing layer is secured to the pad.

2. The remediation pad of claim 1 wherein the reinforcing layer is substantially coextensive with the first major surface.

3. The remediation pad of claim 1 further comprising a second layer of open cell foam material defining third and fourth opposing major surfaces, the third major surface being disposed adjacent the reinforcing layer opposite the first layer and wherein the second layer is secured to the pad.

4. The remediation pad of claim 3 wherein the reinforcing layer is substantially coextensive with the third major surface.

5. The remediation pad of claim 1 further comprising a plurality of fastening structures and wherein the pad defines first and second opposing ends wherein at least one of the fastening structures is disposed on each of the first and second ends whereby the pad is adapted to be connected end-to-end with additional pads having the same configuration.

6. The remediation pad of claim 5 wherein the fastening structures are formed by hook and loop fasteners.

7. The remediation pad of claim 5 wherein the fastening structures are secured to the reinforcing layer.

8. The remediation pad of claim 1 wherein the reinforcing layer is a mesh material.

9. The remediation pad of claim 1 wherein the reinforcing layer is a film material.

10. The remediation pad of claim 1 wherein the open cell foam material comprises EMA.

11. The remediation pad of claim 1 wherein the open cell foam material is approximately 100 percent EMA.

12. The remediation pad of claim 1 further comprising a plurality of pads wherein each of the pads defines first and second opposing ends and includes at least one fastening structure on each of the first and second opposing ends, the fastening structures being detachably securable together whereby the plurality of pads are securable together in an end-to-end configuration to thereby form an endless loop.

13. The remediation pad of claim 3 wherein the first, second, third and fourth major surfaces are all substantially planar surfaces.

14. A method of recovering contaminants from a body of water using a remediation pad of any one of the preceding claims, the method comprising:
securing a plurality of the pads together in an endless loop;
deploying at least a portion of the endless loop in the body of water;
circulating the plurality of pads along the endless loop such that each one of the plurality of pads is repeatedly introduced into the body of water and removed from the body of water; and
expressing liquid from each of the plurality of pads when it is removed from the body of water and before it is returned to the body of water to thereby recover contaminants from the body of water.

15. The method of claim 14 wherein each of the plurality of pads has first and second opposing ends, the first and second opposing ends of each pad being detachably secured to an adjacent one of the plurality of pads to form the endless loop and wherein the plurality of pads are detachably secured together whereby an individual damaged one of the pads can be removed and replaced with an undamaged pad.
